(19) United States
(12) Patent Application Publication
(10) Pub. No.: US 2023/0206734 A1
(43) Pub. Date: Jun. 29, 2023

(54) CATALYTIC CONVERTER ALARM SYSTEM

(71) Applicants: Solmark International, Inc., Dallas, TX (US); Amalgamated LLC, Carson, CA (US)

(72) Inventors: Michael Scott, Dallas, TX (US); Stan Markuze, San Francisco, CA (US); Samuel Aschidamini, Rancho Palos Verdes, CA (US); Chris Auerbach, Scottsdale, AZ (US); Garrett Morrow, Truckee, CA (US)

(21) Appl. No.: 17/710,799

(22) Filed: Mar. 31, 2022

Related U.S. Application Data
(60) Provisional application No. 63/293,629, filed on Dec. 23, 2021.

(51) Int. Cl. G08B 13/19; G08B 13/181

(52) U.S. Cl. CPC G08B 13/19; G08B 13/181; G08B 3/10

(57) ABSTRACT

A catalytic converter alarm includes a housing and mounted thereto are a motion sensor on a first side of the housing, one or more magnets opposite the motion sensor, and a speaker. A controller is mounted within the housing and is coupled to the motion sensor and to the speaker, the controller being configured to cause the speaker to output a sound in response to motion detected by the motion sensor. The controller may output a sound of a first duration in response to the motion and output a sound of a second duration in response to motion of the motion continuing for a threshold time. Operation of the catalytic converter alarm may be controlled by a wireless remote.

### PRIORITY CLAIM

This application claims the benefit of priority from U.S. Provisional Patent Application No. 63/293,629 filed Dec. 23, 2021, the contents of which are incorporated herein by reference.

### FIELD OF THE INVENTION

This application relates to automobile part theft protection, and, more particularly to alarm systems for protecting automobile parts and accessories.

### BACKGROUND OF THE INVENTION

A catalytic converter is included in the exhaust system of a vehicle between the engine and the muffler. The catalytic converter includes surfaces bearing catalysts that break down pollutants in exhaust gasses. These catalysts include precious metals such as platinum, palladium, and rhodium. Expert thieves will often remove the catalytic converters from automobiles in order to obtain these precious metals.

It would be an advancement in the art to provide means for deterring theft of catalytic converters.

### SUMMARY OF THE INVENTION

In one aspect of the invention, an alarm for hindering theft of catalytic converters includes a housing and a motion sensor mounted on a first side of the housing. One or more magnets are secured to the housing opposite the motion sensor and are configured to secure the housing to an underside of a vehicle. A speaker is also mounted to the housing. A controller is mounted within the housing and is coupled to the motion sensor and to the speaker, the controller configured to cause the speaker to output a sound in response to motion detected by the motion sensor.

The speaker may be a cone speaker having a cone angle between 30 and 60 degrees. The motion sensor may be an infrared motion sensor. The controller may be further configured to wirelessly communicate with a remote. A battery may be mounted in the housing and coupled to the controller and the controller may be further configured to cause the speaker to output a low battery sound in response to detecting a state of charge of the battery falling below a threshold condition.

The first sound may have a first duration and the controller may be further configured to, in response to the motion detected by the motion sensor exceeding a threshold duration, output a second sound having a second duration that is longer than the first duration. For example, the first duration may be from 1 to 3 seconds and the second duration may be from 5 to 15 minutes. In some embodiments, the threshold duration is from 2 to 20 seconds.

In a method of use, the alarm is mounted to an underside of a vehicle and the controller causes the speaker to output a sound in response to motion detected by the motion sensor.

### BRIEF DESCRIPTION OF THE DRAWINGS

Preferred and alternative examples of the present invention are described in detail below with reference to the following drawings:

FIG. 1 is an isometric view of a lower side of a catalytic converter alarm in accordance with an embodiment of the present invention;

FIG. 2 is an isometric view of an upper side of the catalytic converter alarm in accordance with an embodiment of the present invention;

FIG. 3 is an isometric view of a charger for the catalytic converter alarm in accordance with an embodiment of the present invention;

FIG. 4 is an isometric view of a key fob remote controller in accordance with an embodiment of the present invention;

FIG. 5 is a diagram illustrating a vehicle having the catalytic converter alarm secured thereto in accordance with an embodiment of the present invention;

FIG. 6 is a schematic block diagram of components of a catalytic converter alarm in accordance with an embodiment of the present invention;

FIG. 7 is a process flow diagram of a method for operating the catalytic converter alarm in accordance with an embodiment of the present invention;

FIG. 8 is an isometric view of a lower side of an alternative embodiment of a catalytic converter alarm in accordance with an embodiment of the present invention;

FIG. 9 is an isometric view of the top side of the catalytic converter alarm of FIG. 8 in accordance with an embodiment of the present invention;

FIG. 10 is an isometric view of a radar sensor suitable for use in any of the foregoing embodiments; and

FIG. 11 is an isometric view of an alternative embodiment of a remote controller in accordance with an embodiment of the present invention.

### DETAILED DESCRIPTION OF THE PREFERRED EMBODIMENTS

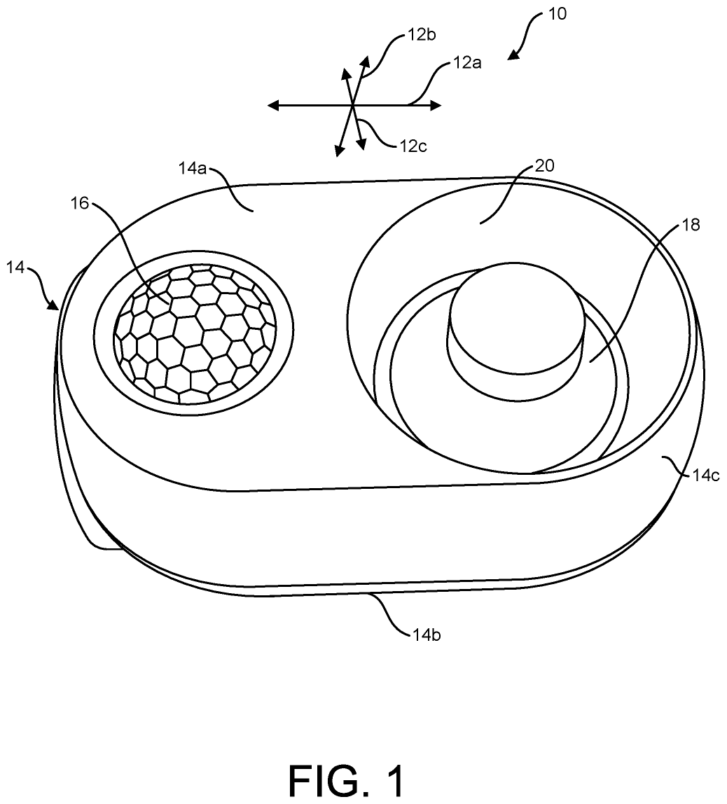

Referring to FIG. 1, a catalytic converter alarm 10 may be understood with respect to a longitudinal direction 12a, vertical direction 12b, and transverse direction 12c. The catalytic converter alarm 10 may include a housing 14 for containing and mounting components of the alarm 10. The housing 14 may be made of a durable material such as acrylonitrile butadiene styrene (ABS) or other durable plastic, metal, composite material (fiberglass, carbon fiber, Kevlar, etc.), or other material.

The housing 14 may have various shapes. In the illustrated embodiment, the housing 14 is longer in the longitudinal direction 12a than in the vertical direction 12b and transverse direction 12c. The housing 14 may include one or more rounded or contoured surfaces. In the illustrated embodiment the housing 14 includes a planar lower surface 14a and a planar upper surface 14b offset from one another along the vertical direction 12b and that are substantially (e.g., within 5 degrees of) parallel to one another and to the longitudinal and transverse directions 12a, 12c. One or more rounded surfaces 14c may extend between the planar lower and upper surfaces 14a, 14b.

The housing 14 may include a motion sensor 16 mounted thereto. The motion sensor 16 may protrude outwardly from the lowermost surface (e.g., planar lower surface 14a) of the housing 14 in order to have a larger field of view. For example, the sensor 16 may be embodied as a hexagonal dome, geodesic dome, other dome composed of other polygons, a sphere, or other three-dimensional shape. The protrusion of the motion sensor 16 outwardly from the lowermost surface of the housing 14 may be such that the motion sensor 16 has a field of view between 120 and 180 degrees in planes parallel to the vertical direction 12b and intersecting the center of the motion sensor 16. Stated differently, the field of view of the motion sensor 16 may be understood as the interior of a cone originating from a point within the motion sensor 16 and having a cone angle from 60 to 90 degrees (i.e., a flat plane). The motion sensor 16 may be embodied as an infrared motion sensor. In other embodiments, the motion sensor 16 is a radar, ultrasonic, tomographic, photo, or other motion sensor. In some embodiments, multiple motion sensors of different types are used, such as an IR sensor and a radar sensor.

The housing 14 may further have a speaker 18 mounted thereto. The speaker 18 may be mounted within an open recess 20 defined by the housing 14. The recess 20 may extend inwardly from the planar lower surface 14a in the vertical direction 12b and may have sides parallel to the vertical direction 12b or angled (e.g., between 0 and 30 degrees) with respect to the vertical direction 12b to form a frustoconical shape. The speaker 18 may be embodied as a cone speaker, such as a deep cone speaker with a cone angle of from 30 to 60 degrees and a depth of 1 to 5 cm. In some embodiments, the speaker 18 is capable of producing sound as loud as at least 100 dB, 120 dB, or 140 dB. In the illustrated embodiment, the speaker 18 and motion sensor 16 are offset from one another along the long dimension of the housing, which is the longitudinal direction 12a in the illustrated embodiment.

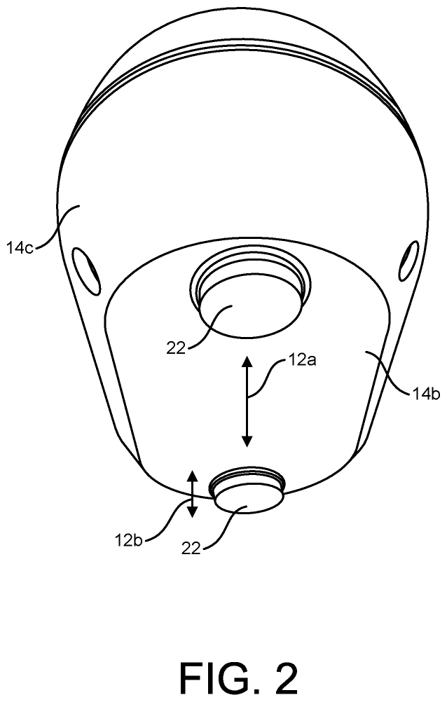

Referring to FIG. 2, the planar upper surface 14b of the housing 14 may have one or more magnets 22 mounted thereto. The magnets 22 may also be offset from one another along the longitudinal direction 12a. The magnets 22 may be mounted to the housing 14 such that they protrude outwardly therefrom along the vertical direction 12b. In other embodiments, the magnets 22 are substantially (e.g., within 1 mm) flush with the planar upper surface 14b or are recessed inwardly from the planar upper surface 14b. The magnets 22 may have planar upper surfaces. The magnets 22 may be embodied as ferrite, neodymium iron boron, samarium cobalt, or aluminum nickel cobalt magnets or other types of magnets.

Although magnets 22 are convenient, other fastening techniques may be used such as cable ties, clamps, screws, adhesive, double sided tape, or the like.

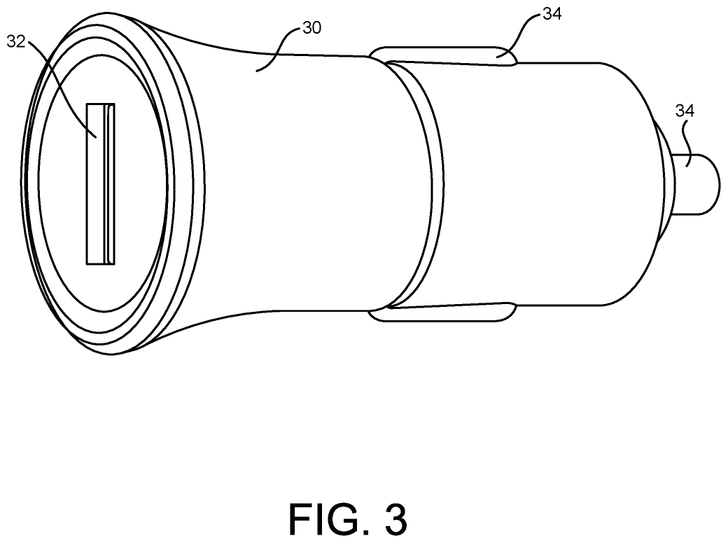

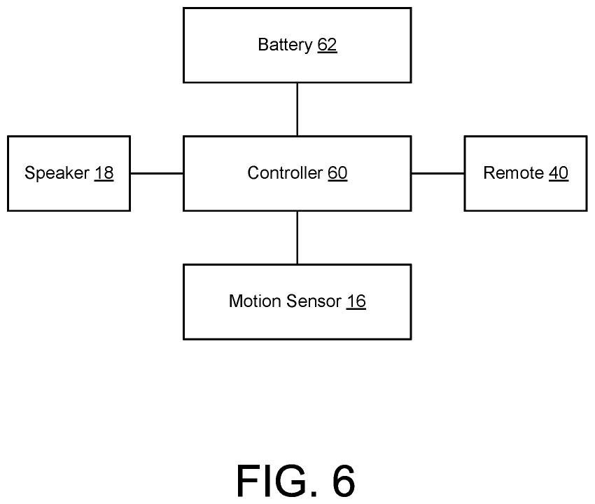

Referring to FIG. 3, the catalytic converter alarm 10 may be rechargeable. For example, an adapter 30 may include a USB port 32 such that the adapter 30 may be connected to a corresponding universal serial bus (USB) socket in the housing 14 in order to charge a battery (see discussion of FIG. 6, below) of the catalytic converter alarm 10. The USB socket in the housing 14 may include a weatherproof cover for preventing water and debris ingress when installed on a vehicle. In the illustrated embodiment, the adapter 30 includes contacts 34 for plugging into a standard 12v outlet. However, other types of adapters may be used. In some vehicles, USB sockets are available such that the adapter 30 may be omitted and the catalytic converter alarm 10 may be connected directly to such a USB socket by a USB cable. The USB socket may be according to any USB type (A, B, Mini, Micro, etc.) according to any USB standard. Other socket types may also be used.

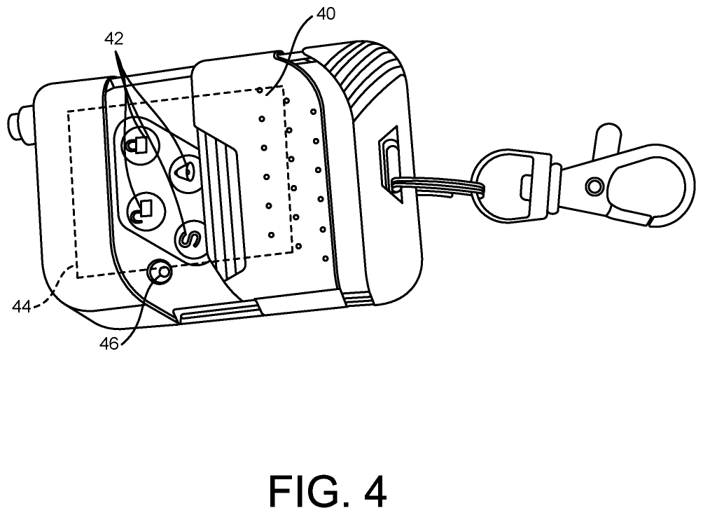

FIG. 4 illustrates an example of a remote 40 that may wirelessly connect to the catalytic converter alarm 10 in order to control operation thereof. In some embodiments the remote 40 communicates wirelessly at a carrier frequency of 433 MHz (+/−10 MHz WILL CONFIRM) The remote 40 may include one or more buttons 42 and corresponding circuitry 44 coupled to the buttons for sending instruction signals to the catalytic converter alarm 10 in response to pressing of the one or more buttons 42. The circuitry 44 may further be configured to receive signals from the catalytic converter alarm 10. The remote 40 may include outputs, such as a light 46, speaker, haptic device, display screen, or other output device. The remote 40 may therefore generate perceptible outputs (light, sound, vibration, etc.) in response to signals received from the catalytic converter alarm 10.

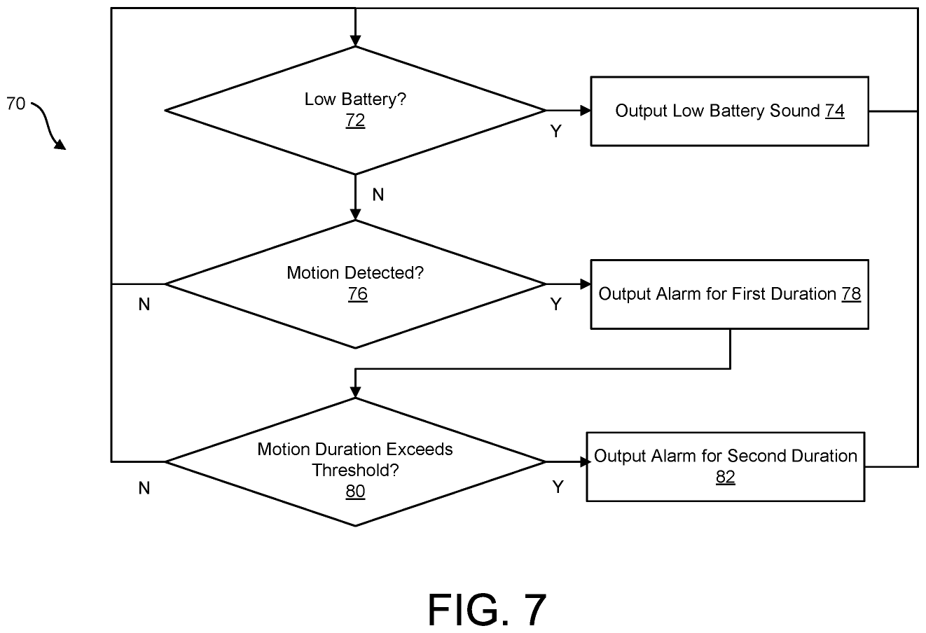

Examples of functions that may be associated with the buttons 42 may include:
1. A locking button that invokes activation of monitoring by the catalytic converter alarm 10 using the motion sensor 16, such as according to the method described below with respect to FIG. 7. The locking button may be a same button that is used to lock a vehicle such that locking of a vehicle invokes monitoring by the catalytic converter alarm 10.
2. An unlocking button that invokes deactivation of monitoring by the catalytic converter alarm 10. The unlocking button may be a same button that is used to unlock the vehicle.
3. A chime button that invokes sounding of a chime or other sound by the catalytic converter alarm 10, such as in order to facilitate finding of the catalytic converter alarm.
4. A battery button that invokes sending of an instruction to the catalytic converter alarm 10 to produce an output corresponding to the state of charge of its battery, e.g., a signal sent to the remote 40 or a number of chimes that correspond to the state of charge of the battery.

Other functions may also be associated by the circuitry 44 with the buttons 42.

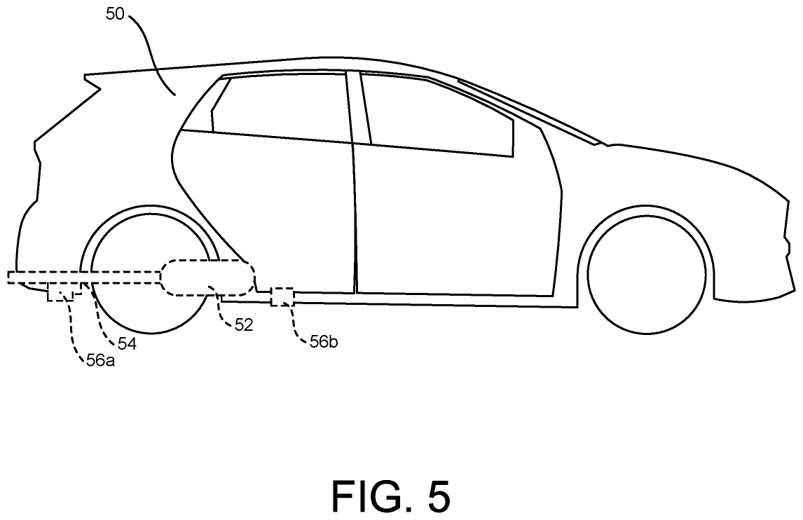

Referring to FIG. 5, in use, the catalytic converter alarm 10 may be secured to the underside of a vehicle 50 by means of the magnets 22. The catalytic converter alarm 10 may preferably be secured to the underside of the vehicle 50 in proximity (e.g., within 10, 20, or 40 cm) to the catalytic converter 52. The catalytic converter alarm 10 may be secured to the vehicle 10 in front of or behind the actual catalytic converter 52 along the longitudinal (front to back) axis of the vehicle. For example, the catalytic converter alarm 10 may be secured at a location 56a behind the catalytic converter 52 in the region of an exhaust pipe 54 exiting the catalytic converter 52. Alternatively, the catalytic converter alarm 10 may be secured on the opposite side at location 56b in front of the catalytic converter 52.

FIG. 6 illustrates components of the catalytic converter alarm 10. The catalytic converter alarm 10 may include a controller 60 that is mounted within the housing 14. The controller 60 may include some or all of an electronic circuit, one or more semiconductor chips, one or more general purpose processors, one or more field programmable gate arrays (FPGA), or other electronic components enabling the controller 60 to perform the functions ascribed herein to the catalytic converter alarm 10.

The controller 60 may be electrically coupled to the motion sensor 16, speaker 18, and a battery 62. The battery 62 may be rechargeable as discussed above, such as in the form of a lithium ion, lithium polymer, nickel cadmium, or other type of rechargeable battery. The controller 60 may also be coupled to the remote 40 by means of a wireless connection.

Referring to FIG. 7, the controller 60 may implement the illustrated method 70. The method 70 may include evaluating 72 a state of the battery 62. If the battery is found 72 to have a state of charge below a threshold, the method 70 may include outputting 74 a low battery sound. For example, the controller 60 may cause the speaker 18 to output a chime, verbal message, series of chimes, or other signal that indicates a low battery. The controller may additionally or alternatively send a signal to the remote 40 instructing the remote 40 to generate a perceptible output (sound, light, haptic, etc.) indicating a low battery.

The remaining steps of the method 70 may be conditioned on the catalytic converter alarm 10 being activated in response to a signal from the remote 40, e.g., in response to a user pressing the locking button 42 described above. The method 70 may include evaluating 76 whether motion has been detected based on the output of the motion sensor 16. The evaluation 76 may include evaluating whether detected motion is of sufficient magnitude and/or duration to indicate potential theft of the catalytic converter. In some embodiments, the motion sensor 16 itself or in combination with an algorithm implemented by the controller 60 can distinguish between detected humans or animals and inanimate objects. For example, the motion sensor 16 may be an infrared sensor capable of detecting infrared radiation emitted by a human or animal. Accordingly, the evaluation 76 may include evaluating whether a human or animal was detected. In some embodiments, transitory shadows, passing vehicles, or other motion may be ignored by the controller 60 whereas motion below the vehicle 50 is found 76 to meet a threshold condition.

If the motion is found 76 to be detected, the controller 60 may cause the speaker 18 to output 78 an alarm for a first duration. For example, the first duration may be from one to three seconds, such as two seconds. If detected motion is found 80 to continue for a duration exceeding a threshold time following the motion detected at step 76, the controller may cause the speaker 18 to output 82 an alarm for a second duration, e.g., from 5 to 20 minutes, e.g., 4 minutes, 10 minutes. The threshold time may be a value from 20 to 120 seconds, such as 60 seconds. The evaluation of step 80 may take various forms. For example, the condition of step 80 may be found to be met if motion is detected again within the threshold time following detecting motion at step 76. The condition of step 80 may be found to be met if motion is detected at least N times within the threshold time following detecting motion at step 76, e.g., 2, 3, 4, or some other number of times. The condition of step 80 may be found to be met where motion is detected continuously for the threshold time following the detection of step 76. What is sufficient to be detected motion at step 80 may be determined in the same way or a different way from the approach described above with respect to step 76.

Outputting 78, 82 sound from the speaker 18 may be supplemented with, or replaced by, sending a signal to the remote 40 that will cause the remote 40 to produce a perceptible output. The method 70 may be repeated periodically while the catalytic converter alarm 10 is activated such as with a period from 50 ms to 2 seconds.

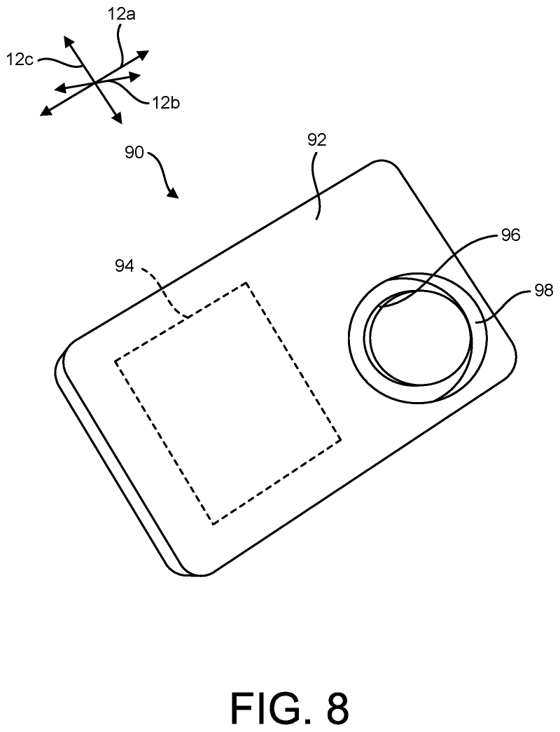

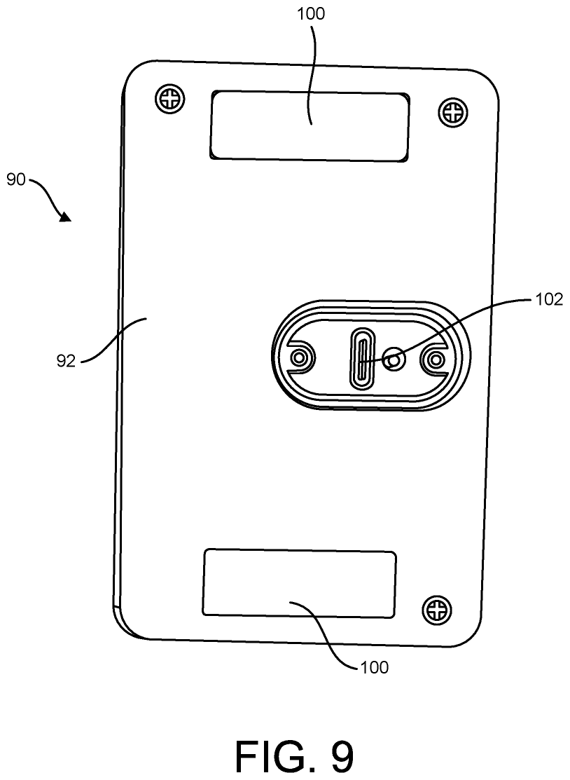

Referring to FIGS. 8 and 9, a catalytic converter alarm may be embodied as the illustrated catalytic converter alarm 90. The alarm 90 may include a battery 62 and controller 60 that may function as described above with respect to the alarm 10. The catalytic converter alarm 90 may include a housing 92. The housing 92 may be made of any of the materials cited above with respect to the housing 14. The housing 92 in the illustrated embodiment has a cuboid shape with rounded corners and possibly other features. In particular, the housing 92 may include a planar upper surface and a planar lower surface opposite one another. For example, the cuboid shape may have a length of 3.5 inches in the longitudinal direction 12a, 1 inch in the vertical direction 12b, and 2.25 inches in the transverse direction 12c. A sensor 94 is mounted within the housing 90 and may be embodied as a radar sensor. Accordingly, at least the planar lower surface of the housing 90 may be made of a material that is transparent to radar, which is the case for most plastics. Accordingly, the housing 90 may not have external openings or other features for facilitating operation of the sensor 94. For example, the planar lower surface may lack openings over the sensor 94.

The alarm 90 may further include a speaker 96. The speaker 96 may be implemented using any of the approaches described above with respect to the speaker 18. The speaker 96 may be positioned within a well 98 extending inwardly into the housing 90, such as inwardly from an opening defined by the planar lower surface of the housing 90.

Referring specifically to FIG. 9, the upper surface of the housing 90 may have one or more magnets 100, such as two magnets, secured thereto or accessible therethrough. In the illustrated embodiments, the magnets are substantially flush with the planar upper surface, e.g., protruding no more than 2 mm, no more than 1 mm, or no more than 0.5 mm. The magnets may have any of the attributes described above with respect to the magnets 22. In the illustrated embodiment, the magnets 100 are rectangular, though other shapes, including round, may also be used. The illustrated rectangular magnets 100 may have increased surface area to strengthen fastening force exerted by the magnets 100.

In the illustrated embodiment, a port 102 for charging and/or communicating with the alarm 90 may also be mounted facing outwardly from the planar portion of the upper surface and accessible through an opening in the planar upper surface. In this manner, when the alarm 10 is mounted to a structure of the vehicle 50, the port 102 is covered by that structure. The port 102 may be used with or without a removable cover. The port 102 may have any of the attributes described above with respect to the port 32.

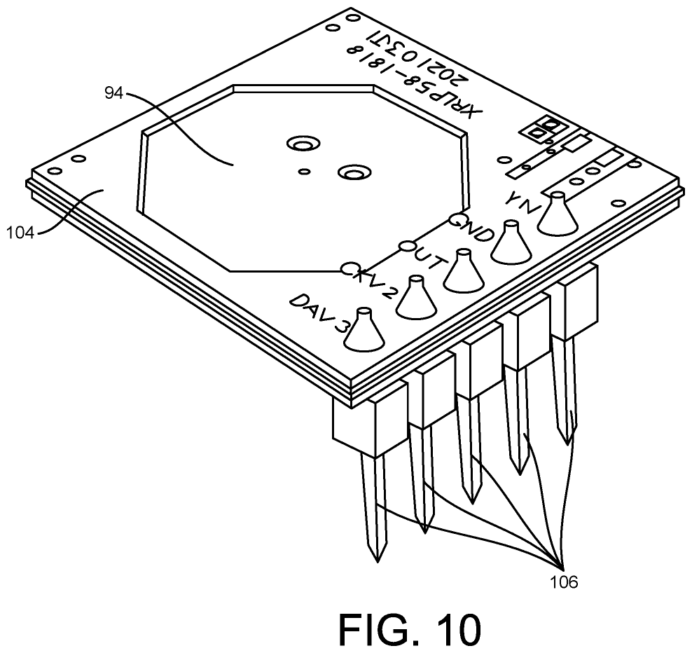

Referring to FIG. 10, the sensor 94 may be embodied as a radar sensor 94, such as a Doppler radar sensor. The emitting antennas or circuits of the Doppler radar sensor may be closer to the planar lower surface than to the planar upper surface, such as in contact with or within 3 mm of the planar lower surface. When the alarm 90 is activated, the radar sensor 94 may operate actively: periodically sending out pulses and detecting any frequency shifts in reflected pulses that indicate detected movement. The radar sensor 94 may have a field of view as defined above with respect to the sensor 16. However, the radar sensor 94 may provide a continuous field of view, rather than a slotted field of view as is the case for infrared sensors. The radar sensor 94 may have greater sensitivity and a higher coverage range as compared to an infrared sensor.

The radar sensor 94 may be mounted to a printed circuit board 104 including pins 106 for connecting to a circuit board implementing the controller 60. The controller 60 may implement the method 700 using outputs of the radar sensor 94 to detect movement and the duration of movement.

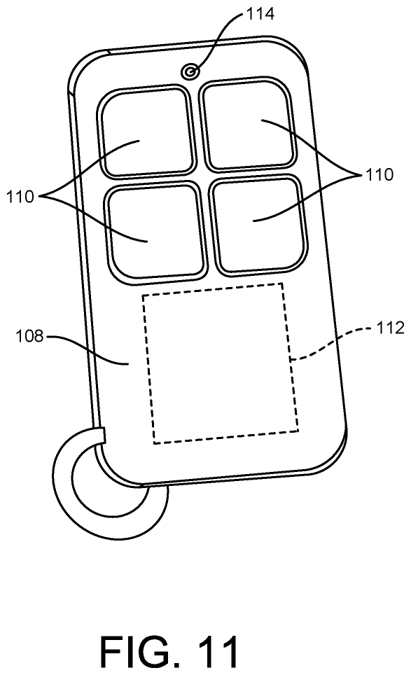

FIG. 11 illustrates an alternative implementation of a remote controller 108. The remote controller 108 may operate with respect to the alarm 90 in the same manner as the remote 42 with respect to the alarm 10. The remote controller 108 include buttons 110, control circuit 112, and an indicator light 114 or other output device that may operate in the same manner as described above with respect to the buttons 42, circuitry 44, and light 46. While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An alarm for hindering theft of catalytic converters comprising:
a housing;
a motion sensor mounted on a first side of the housing;
one or more magnets secured to the housing opposite the motion sensor and configured to secure the housing to an underside of a vehicle;
a speaker mounted to the housing; and
a controller within the housing and coupled to the motion sensor and to the speaker, the controller configured to cause the speaker to output a sound in response to motion detected by the motion sensor.

2. The alarm of claim 1, wherein the speaker is a cone speaker having a cone angle between 30 and 60 degrees.

3. The alarm of claim 1, wherein the motion sensor is one of an infrared motion sensor and a radar sensor.

4. The alarm of claim 1, wherein the controller is further configured to wirelessly communicate with a remote.

5. The alarm of claim 1, further comprising a battery mounted in the housing and coupled to the controller.

6. The alarm of claim 5, wherein the controller is further configured to cause the speaker to output a low battery sound in response to detecting a state of charge of the battery falling below a threshold condition.

7. The alarm of claim 1, wherein the sound is a first sound having a first duration and the controller is further configured to:
in response to the motion detected by the motion sensor exceeding a threshold duration, outputting a second sound having a second duration that is longer than the first duration.

8. The alarm of claim 7, wherein the first duration is from 1 to 3 seconds and the second duration is from 5 to 15 minutes.

9. The alarm of claim 7, wherein the threshold duration is from 20 to 120 seconds.

10. A method comprising:
providing a catalytic converter alarm including:
a housing;
a motion sensor mounted on a first side of the housing;
one or more magnets secured to the housing opposite the motion sensor;
a speaker mounted to the housing; and
a controller within the housing and coupled to the motion sensor and to the speaker;
mounting the catalytic converter alarm to an underside of a vehicle; and
causing, by the controller, the speaker to output a sound in response to motion detected by the motion sensor.

11. The method of claim 10, wherein the speaker is a cone speaker having a cone angle between 30 and 60 degrees.

12. The method of claim 10, wherein the motion sensor is one of an infrared motion sensor and a radar sensor.

13. The method of claim 10, further comprising, receiving, by the controller, a wireless signal from a remote and activating the catalytic converter alarm in response to the wireless signal.

14. The method of claim 10, further comprising a battery mounted in the housing.

15. The method of claim 14, further comprising:
detecting, by the controller, a state of the battery;
determining, by the controller, that the state of the battery is below a threshold condition; and
causing, by the controller, the speaker to output a low battery sound in response to detecting the state of charge of the battery falling below the threshold condition.

16. The method of claim 10, wherein the sound is a first sound having a first duration, the method further comprising:
in response to the motion detected by the motion sensor exceeding a threshold duration, causing, by the controller, the speaker to output a second sound having a second duration that is longer than the first duration.

17. The method of claim 16, wherein the first duration is from 1 to 3 seconds and the second duration is from 5 to 15 minutes.

18. The method of claim 16, wherein the threshold duration is from 20 to 120 seconds.

19. An alarm for hindering theft of catalytic converters comprising:
a housing including a first planar portion and a second planar portion opposite the first planar portion;
a Doppler radar motion sensor mounted in the housing closer to the first planar portion than to the second planar portion;
a speaker positioned over an opening defined in the first planar portion;
a charging port accessible through an opening in the second planar portion;
one or more magnets secured to the housing substantially flush with the second planar portion and configured to secure the housing to an underside of a vehicle;
a battery mounted within the housing and coupled to the charging port; and
a controller within the housing and coupled to the Doppler radar motion sensor, speaker, and the battery, the controller configured to cause the speaker to output a sound in response to motion detected by the Doppler radar motion sensor.

20. The alarm of claim 19, wherein the sound is a first sound having a first duration and the controller is further configured to:
in response to the motion detected by the Doppler radar motion sensor exceeding a threshold duration, outputting a second sound having a second duration that is longer than the first duration.
